(19) United States
(12) Patent Application Publication
(10) Pub. No.: US 2003/0103630 A1
(43) Pub. Date: Jun. 5, 2003

(54) Device for receiving digital radio signals

(76) Inventor: Bernhard Horn, Forchheim (DE)

Correspondence Address: Michael J McGovern, Quarles & Brady, 411 East Wisconsin Avenue, Milwaukee, WI, 53202-4497, US

(21) Appl. No.: 10/204,784

(22) PCT Filed: Feb. 10, 2001
(86) PCT No.: PCT/EP01/01490

(30) Foreign Application Priority Data
Feb. 19, 2000 (DE) 10007710.2

(51) Int. Cl. H04H 5/00

(52) U.S. Cl. 381/2; 381/3

(57) ABSTRACT

The invention relates to a device for receiving digital radio signals. The device has a digital receiving appliance comprising a tuner and a demodulator that is connected to said tuner. The device also contains a first microcomputer. The demodulator and the first microcomputer are connected to a supplementary module by an appliance interface of the digital receiving appliance. Said supplementary module has a second microcomputer and a signal processing unit which is controlled by said second microcomputer and which is connected to the appliance interface at the output end. The supplementary module also contains at least one other signal output through which the signals that are processed in the signal processing unit can be output.

. . . the end sale prices are high for digital receiving appliances. Furthermore, such digital receiving appliance has a complicated structure so that the equipment developer must satisfy high requirements. Furthermore, in practice, most purchasers of such digital receiving appliances never use many of the functions of the equipment. Yet, these purchasers of the equipment must pay the high prices for digital receiving appliances.

A remote control for a television cable network system is known from EP-A2-0 849-948. This system uses a set-top box, which is equipped with a tuner, a demodulator and a microcomputer.

The task of the invention is to provide a device for receiving digital radio signals and does not have the disadvantages described above.

This task is solved by a device with the characteristics given in claim 1. Advantageous embodiments and further developments of the invention are given in the dependent claims.

The advantages of the invention consist especially in the fact that the manufacturing cost and thus the final sale price of a digital receiving appliance is low. Only users who desire to be able to carry out additional special functions pay the higher cost. These are related to the purchase of one or several supplementary modules which has (have) a signal processing unit for performing the desired special supplementary functions.

Another advantage of the invention consists in the fact that a digital receiving appliance according to the invention is secure in the future. Namely, if received signals with new codings occur in the course of the life of such an appliance, then this circumstance can be taken into consideration simply by the fact that the client acquires a new, comparatively low-cost supplementary module which is suitable for decoding the received signals with the new coding. There is even a possibility to program a supplementary module inserted into the digital receiving appliance using software programs contained in the received digital data stream in such a way that it is suitable for receiving and processing the received signals with the new coding.

If additional outputs are provided in the supplementary module, as it is given in claims 2, 3, 5, 6, 7, 9 and 10, then it is not necessary to provide such additional outputs on the digital receiving appliance.

The objects of claims 4, 6, 7, 8 and 11 are preferred embodiments of the signal processing unit contained in the supplementary module.

If the supplementary module has a remote control receiver, as it is given in claim 12, then, advantageously, control commands which are input with the aid of the control unit of the supplementary module can be further conducted through the microcomputer of the supplementary module to the microcomputer of the digital receiving appliance. This then performs control processes which are determined by the control unit of the supplementary module.

Using a device with the characteristics given in claim 13, it becomes possible to enter control commands using an outside remote control, which are then automatically converted to data understood by the microcomputer of the digital receiving unit. This then produces control data for the affected component of the device.

The advantages of the characteristic given in claim 14 consist in the fact that there is a possibility of recording on a storage medium signals received by the digital receiving appliance through one of its inputs, as well as the possibility of processing signals read by a storage medium and/or to represent them on the screen of a television receiver connected to the digital receiving appliance.

Preferably, the digital receiving appliance is provided for containing various storage media, so that, for example, when the user so desires, recording of received audio signals may occur which are processed in supplementary module 12 and from there are transferred back to the digital receiving appliance. Furthermore, if the user so desires, reading and display of data recorded on a CD-ROM may occur, where these data can be, for example, the catalog of a mail-order company, telephone book data or also descriptions of landscapes. If the storage medium is an MP3 memory card, then the signals stored there can be read, decoded and emitted in the form of audio signals through loudspeakers. Furthermore, received music signals can be provided with an MP3 coding and can be stored on the MP3 memory card.

If the digital receiving appliance is provided with a telephone interface, then catalog or product data read from a CD-ROM can be used directly to place an order to a mail-order company through the telephone. Preferably, in this case, personal data identifying the user are stored in a memory of the digital receiving appliance or of the supplementary module, which then can be transmitted automatically together with the product data.

If the supplementary module has an additional data input, as it is given in claim 19, then audio-, video- or control data, which are not derived from the HF input of the digital receiving appliance can be processed and transferred.

The selection of signals to be processed in the supplementary module can be done either directly through a control unit assigned to the supplementary module or with the aid of control data which were entered with the aid of the control unit of the digital receiving appliance and were transferred from the microcomputer of the digital receiving appliance to the microcomputer of the supplementary module.

Alternatively or additionally to the possibility of providing a recording device for a memory card in the digital receiving appliance, such a recording device for a memory card can also be provided in the supplementary module.

Other advantageous properties of the invention follow from the explanation of a practical example with the aid of the FIGURE, which is a circuit diagram of a device for receiving digital radio signals.

The device shown has a satellite receiver antenna 2, the output signals of which are introduced to a digital receiving appliance through its input connection 3. The digital receiving appliance 1 is connected with a telephone 20 through its telephone interface 19. The telephone interface 19 can be designed as a modem interface, DECT interface, radio interface, infrared interface or telephone cable connection interface. To reproduce signals which were received by the digital receiving appliance, a television receiver 11 is connected to output 10 of the digital receiving appliance. Furthermore, the digital receiving appliance 1 is connected through an equipment interface 6 to a supplementary module 12. Among others, a remote control emitter 17 is assigned to the latter for entering control commands.

The device shown can be operated in various types of operation.

In a first type of operation, the signals derived by the satellite antenna 2 are introduced to the digital receiving appliance 1, which is a settop box in this case, through its input connection 3. From there, they are introduced through tuner 4 to a demodulator 5. At the output of this, digital data are available in the form of an MPEG transport stream. This transport stream contains a multiplex of several services. A service can be one or several television programs, one or several radio programs, additional data for the radio or television programs, such as teletext data, multilingual audio data, a program guide and subtitle data. Furthermore, a service may also contain data services or programs in the EDP sense.

This MPEG transport stream is introduced to a signal processing circuit 8 into in which the selection of a desired service or of a subdata stream corresponding to the service is carried out. Furthermore, a conversion of the selective data stream is performed in signal processing circuit 8 into signals, which are introduced to the television receiver or audio reproduction equipment through output 10, and then they can be represented on the screen or emitted through the loudspeaker.

The control of tuner 4, the demodulator 5 and signal processing circuit 8 is done through control signals which are generated in microcomputer 7 of the settop box. Microcomputer 7 produces the said control signals as a function of control commands which are either entered with the aid of a control unit of the settop box, not shown, or with the aid of a control unit 17, which is assigned to the supplementary module 12 directly.

The control commands entered with the aid of control unit 17 are received by unit 16, which has a remote control receiver, and are further conducted through microcomputer 15 of the supplementary module as well as through interface 6 to the microcomputer 7 of settop box 1. Unit 16 can have advantageously a code converter for remote control commands in which the control commands emitted by the remote control emitter 17 can be converted into a remote control code which is understood by microcomputer 7 of the settop box.

In another type of operation of the device shown, the signals derived from satellite antenna 2 can be introduced to the digital receiving appliance 1, which is a settop box, through its input connection 3. From there, they are introduced to demodulator 5 through tuner 4. The demodulator has digital data available in the form of an MPEG transport stream at its output, which, as already explained above, has a multiplex of several services. One of these services contains digital audio signals, which contain stereoscopic sound audio data, which include more than the usual 2-channel stereo data. Such stereoscopic sound audio data can be, for example, Dolby-Surround audio data or AC3-coded audio data.

The settop box 1 itself is not able to decode such stereoscopic sound audio data. Consequently, these data contained in the MPEG transport stream are introduced to the supplementary module 12 through equipment interface 6. This module has a signal processing unit 14 in which a decoder for stereoscopic sound audio data is provided, for example, a Dolby-Surround decoder or an AC3-decoder.

The decoded stereoscopic sound audio data are further conducted to two signal outputs 13 of the supplementary module 12, which are signal outputs for digital audio signals.

Additionally or alternatively to this, the signal processing unit 14 may also have a circuit which converts the decoded digital audio signals into six analog audio signals, each of which are provided for a loudspeaker. These analog audio signals are each made available at an analog signal output of the supplementary module and are introduced from there to the particular loudspeaker.

Consequently, in supplementary module 12, audio data, which are present in the MPEG transport stream in a predetermined stereoscopic sound audio format or in another special audio data format, are separated from the MPEG transport stream and are decoded in the signal processing unit 14, depending on the existing format. The decoded signals can be made available then at the outputs of the supplementary module and/or can be introduced to the settop box through equipment interface 6.

To separate the above subdata stream, the corresponding identification signals of the subdata stream has to be provided to the supplementary module 12, so that the supplementary module can independently extract and decode this subdata stream. The identification signals can be entered through commands of the control unit of the settop box or of the supplementary module. Alternatively to this, it is also possible to separate the said subdata stream already in the settop box itself and then introduce the predecoded audio data to the supplementary module through equipment interface 6.

An essential advantage of the described application of a supplementary module for decoding of audio data, which are present in a special data format, consists in the fact that the basic cost for the settop box can be kept low. Only those users who would wish to decode the above special data too, will incur additional costs by the purchase of the described supplementary module.

Different stereoscopic sound audio formats or other different audio formats or the corresponding decoder can be realized in different supplementary modules, without the settop box having to know the properties of the supplementary module. Consequently, such a system is open for future audio data formats. In future receiving appliances, the already existing supplementary modules can be used again. They will not become unusable.

For example, the said signal-processing unit 14 may also contain a protocol converter for audio signals, where the protocol-converted audio data are led back either to the settop box 1 or can be made available at one of the outputs of the supplementary module 12.

A preferred embodiment consists in that compressed audio signals, for example, MP3-coded audio signals, are made available at one of the outputs of the supplementary module 12. These can be further led to an external memory, which is a component of a corresponding play-back equipment.

Another preferred embodiment of the invention consists in providing an infrared emitter in unit 16 of supplementary module 12. Using this infrared emitter, audio signals which were processed in settop box 1 or in signal processing unit 14 can be transferred without a cable to the loudspeaker, which is not shown, and then can be emitted by this.

In another type of operation of the said device, such a memory 9, especially an MP3 memory card, is inserted in receiving device 9a of settop box 1 or of supplementary module 12. This memory card can be written on, so that both storage of the received audio signals as well as reproduction of an externally recorded-on memory card can be achieved.

The recording device 9a is preferably designed in such a way that it is suitable for recording different types of storage media, for example, a CD-ROM, an audio CD, a DVD, an MP3 memory card or a semiconductor memory card. As a result of this, the device shown is able, in a flexible manner, to record and/or replay video-, audio- and other data onto or from a storage medium, where the data to be recorded can be derived either from the output of the demodulator 5 or from the output of signal-processing unit 14.

1. Device for receiving digital radio signals, with a digital receiving appliance (1), which has a tuner (4), a demodulator (5) connected to the tuner and a first microcomputer (7),
characterized by the fact
that [whereby] the demodulator (5) and the first microcomputer (7) are connected through an interface (6) of the digital receiving appliance to a supplementary module (12), which has a second microcomputer (15) and a signal-processing unit (14) controlled by the second microcomputer, which, on the output side, is connected with equipment interface (6) and where the supplementary module (12) has at least one additional signal output (13, 16) through which the signals processed in the signal-processing unit (14) can be output.

2. Device according to claim 1,
characterized by the fact that
the supplementary module (12) has several signal outputs.

3. Device according to claim 1 or 2,
characterized by the fact that
an additional signal output is an output (16) for infrared signals.

4. Device according to one of the previous claims,
characterized by the fact that
the signal-processing unit (14) has an audio-signal processing unit.

5. Device according to one of the previous claims,
characterized by the fact that
another signal output is a digital audio signal output.

6. Device according to one of the previous claims,
characterized by the fact that
the signal-processing unit (14) has a Dolby-Surround decoder and the supplementary module (12) has two additional signal outputs for digital audio signals.

7. Device according to one of the previous claims,
characterized by the fact that
the signal-processing unit (14) has a Dolby-Surround decoder and that the supplementary module (12) has six additional signal outputs for analog audio signals.

8. Device according to one of the previous claims,
characterized by the fact that
the signal-processing unit (14) has a protocol converter for audio signals.

9. Device according to one of the previous claims,
characterized by the fact that
another output is an output for compressed audio signals.

10. Device according to one of the previous claims,
characterized by the fact that
another output is an output for MP3-coded audio signals.

11. Device according to one of the previous claims,
characterized by the fact that
the signal-processing unit (14) has a synthesizer.

12. Device according to one of the previous claims,
characterized by the fact that
the supplementary module (12) has a remote control receiver (16).

13. Device according to claim 12,
characterized by the fact that
the supplementary module (12) has a code converter (16) for remote control signals.

14. Device according to one of the previous claims,
characterized by the fact that
the digital receiving appliance (1) has a recording device (9a) for a storage medium (9).

15. Device according to claim 14,
characterized by the fact that
the storage medium (9) is a CD-ROM, an audio CD, a DVD, an MP3 memory card or a semiconductor memory card.

16. Device according to claim 14 or 15,
characterized by the fact that
the storage medium (9) is writeable.

17. Device according to one of the previous claims,
characterized by the fact that
the digital receiving appliance (1) is provided with a telephone interface (19).

18. Device according to one of the previous claims,
characterized by the fact that
the telephone interface (19) is a modem interface, a DECT interface, a radio interface, an infrared interface or a telephone cable connection interface.

19. Device according to one of the previous claims,
characterized by the fact that
the supplementary module (12) has an additional data input (18).

20. Device according to claim (19),
characterized by the fact that
the additional data input (18) is a control signal input.

21. Device according to one of claims 14 to 20,
characterized by the fact that
the storage medium (9) is provided for storing audio and/or video signals which are derived from the output of the demodulator (5) or from the output of the signal-processing unit (14).

22. Device according to one of the previous claims,
characterized by the fact that
the signals provided at the output of the demodulator (5) correspond to an MPEG transport stream.

23. Device according to claim 22,
characterized by the fact that
the second microcomputer (15) introduces control data, describing a subdata stream of the MPEG transport stream, to the signal-processing unit (14).

24. Device according to claim 23,
characterized by the fact that
the control data describing the subdata stream are generated in the first microcomputer (7).

25. Device according to claim 23,
characterized by the fact that
the control data describing the subdata stream are control data derived from the remote control receiver (16) of the supplementary module (12).

26. Device according to one of the previous claims,
characterized by the fact that
the first microcomputer (7) generates control data as a reaction to control commands, which are derived from the remote control receiver (16) of the supplementary module and are introduced through the code converter for remote control signals to the first microcomputer (7).

27. Device according to one of the previous claims,
characterized by the fact that
the supplementary module (12) is realized in the form of a flat, diskette-like component, which can be inserted in a receiving appliance through its digital input slit and when it is inserted, is contacted with the equipment interface (6).

28. Device according to one of the previous claims,
characterized by the fact that
the supplementary module (12) has a recording device (9a) for a storage medium.

29. Device according to one of the previous claims,
characterized by the fact that
the digital receiving appliance is a settop box or a digital television receiver.
